(19) United States
(12) Patent Application Publication
(10) Pub. No.: US 2014/0374545 A1
(43) Pub. Date: Dec. 25, 2014

(54) HOUSING AND WIRE HOLDER THEREOF

(71) Applicant: YAZAKI CORPORATION, Tokyo (JP)

(72) Inventor: Manabu SAKAI, Makinohara-shi (JP)

(73) Assignee: YAZAKI CORPORATION, Tokyo (JP)

(21) Appl. No.: 14/482,094

(22) Filed: Sep. 10, 2014

Related U.S. Application Data
(63) Continuation of application No. PCT/JP2013/058181, filed on Mar. 13, 2013.

(30) Foreign Application Priority Data
Mar. 13, 2012 (JP) 2012-056199

(51) Int. Cl. H01R 4/24

(52) U.S. Cl. CPC H01R 4/2433
USPC 248/68.1

(57) ABSTRACT

A wire holder includes a body, a cover covering the body, and a hinge connecting the body and the cover. The cover holds a plurality of wires between the cover and the body. A lock mechanism which locks the body and the cover is provided at an opposite end portion of the wire holder to the hinge. A shaft is provided at a side surface of the opposite end portion of the wire holder to the hinge. The hinge includes a connection part which protrudes from the wire holder in a state where the body and the cover are locked by the lock mechanism.

### CROSS REFERENCE TO RELATED APPLICATIONS

This application is a continuation of PCT application No. PCT/JP2013/058181, which was filed on Mar. 13, 2013 based on Japanese Patent Application (No. 2012/056199) filed on Mar. 13, 2012, the contents of which are incorporated herein by reference.

### BACKGROUND OF THE INVENTION

1. Field of the Invention

The invention is related to an interior light assembly for a vehicle provided on a vehicle ceiling, and more particularly to, a housing which is a part of an interior light assembly for a vehicle and a wire holder provided in the housing.

2. Description of the Related Art

FIG. 11 is an exploded perspective view of an interior light assembly for a vehicle that is a subject of the invention.

In FIG. 11, an interior light assembly 1 for a vehicle has a busbar 40, a housing 50, bulb 60, contact 70, switch knob 80 and a lens 90 in order from the upper. The respective constitutional elements are briefly described in the below.

In FIG. 11, the busbar 40 is a long plate made of a copper alloy for connecting parts of the switch knob 80, the contact 70 and the bulb 60 mounted on the housing 50, which should be electrically connected. The busbar 40 is constituted by a plurality of long plates. Among them, one of the long plates is provided with a crimping blade 50M (refer to FIGS. 5 and 6).

In FIG. 11, the busbar 40 is fitted into the housing 50 from the upper to form a lamp function part.

In FIG. 11, the housing 50 is a resin member that accommodates therein the busbar 40, the bulb 60, the contact 70 and the switch knob 80, except for the lens 90. A surface of the housing 50 facing the lens 90 has a substantially rectangular surface and is provided with a plurality of engaging protrusions 50K over an entire periphery that protrudes at peripheral edges thereof in a more outward direction than a vertical plane. In this illustrative embodiment in FIG. 11, six engaging protrusions over an entire periphery are provided. A wire holder (refer to FIG. 1) that will be described later is mounted on a central part of the housing 50.

The bulb 60 is a light source of 12V/5W and turns on/off by a signal that is output from the vehicle. The bulb 60 is accommodated on a bottom of a bulb accommodation part having a mortar shape formed in the housing 50 and is configured so that a light generated from the bulb 60 is reflected on the bulb accommodation part and is thus directed towards the lens 90.

The contact 70 is a contact made of a copper alloy and is integrally formed with a press-fitting part 70P, which is press-fitted between two accommodation parts 80S of the switch knob 80 and leg parts 70S, 70S that respectively extend obliquely upwards in a reverse direction at the same side from two points equidistantly spaced from a center of the press-fitting part 70P. The switch knob 80 is formed by resin molding a pressing part 80N having a flat and elongated lid shape, two pillar-shaped accommodation parts 80S at an interval standing from the pressing part 80N in a vertically upward direction of FIG. 11 and a shaft hole 80H that is formed at a center between the two accommodation parts 80S and is a center of seesaw movement. When the contact 70 is press-fitted between the two accommodation parts 80S of the switch knob 80, a seesaw switch is completed. By the seesaw movement of the seesaw switch, when one side of the pressing part is pressed, tips of the leg parts 70S of the contact 70 are contacted to a mating terminal and when the other side is pressed, the tips of the leg parts 70S of the contact 70 are separated from the mating terminal and are connected to the other terminal.

The lens 90 is a resin member having a rectangular shape and functioning as a lens enabling the light from the bulbs 60 to pass therethrough. The lens 90 is provided with a plurality of engaging members 90L having engaging holes 90K over an entire periphery of a peripheral edge. There are two engaging members on each long side and one engaging member on each short side, therefore a total of six engaging members are provided over an entire periphery, in this illustrative embodiment. And, the lens 90 is formed with insertion openings 90N into which the switch knobs 80 are inserted. There are three insertion openings, in this illustrative embodiment. In FIG. 11, a backside of the lens 90 is a design surface. In the below, an assembling sequence of the interior light assembly for a vehicle having the above parts is described.

The first sequence is a step of press-fitting of the contact 70 into the switch knob 80. The press-fitting part 70P of the contact 70 is press-fitted into press-fitting recesses of the two pillar-shaped accommodation parts 80S of the switch knob 80 from the upper of the drawing, so that the contact 70 is attached to the switch knob 80.

The second sequence is a step of mounting of the busbar 40 to the housing 50. The busbar 40 is attached to a predetermined position of the housing 50. The busbar 40 is formed at predetermined positions with pin insertion holes. When the busbar 40 is attached to a predetermined position of the housing 50, pins provided to stand from the housing 50 are inserted into the pin insertion holes of the busbar 40 and the inserted pins are heat-melted, so that the busbar 40 is fixed to the housing 50.

The third sequence is a step of mounting of the switch knob 50 to the housing 50. The switch knobs 80 assembled in the first sequence are mounted to the housing 50 assembled in the second sequence and an assembly of the contacts 70 and the bulbs 60 are also mounted to the housing.

The fourth sequence is a step of mounting of the lens 90 to the housing 50. The lens 90 is mounted to the housing 50 assembled in the third sequence The engaging protrusions 50K of the housing 50 are engaged with the engaging holes 90K of the engaging members 90L. When all the parts are attached as described above, the interior light assembly 1 for a vehicle is completed.

As described above, the wire holder is mounted to the housing. PTL 1 discloses a technology relating to a wire holder support part provided to the housing and a wire holder provided to the wire holder support part.

According to the disclosure in PTL 1, the wire holder is mounted to a wire harness and has a wire aligning part that holds a plurality of wires configuring the wire harness in parallel, an attaching shaft part that is provided at a position spaced at an appropriate distance from the wire aligning part towards one side and an attaching engaging part that is provided at a position spaced at an appropriate distance from the wire aligning part towards the other side.

Also, the holder support part has a harness connection part to which the wire harness is connected, a holder shaft support part that rotatably supports the attaching shaft part, a lock part that is engaged with the attaching engaging part of the wire holder rotating about the holder shaft support part serving as a rotation support point and thus fixes the wire holder and a terminal fixing part having a plurality of crimping terminals that is arranged between the holder shaft support part and the lock part in correspondence to the wire arrangement on the wire aligning part so that a crimping connection of the wire aligning part with the wire is completed when the wire holder is fixed to the lock part.

FIG. 12 is a perspective view of a wire holder support part 500U of a housing and a wire holder 100 that is mounted thereto, which configure a related art of the invention having improved the technology of PTL 1.

As shown in FIG. 12, the wire holder 100 is preliminarily provided with a plurality of wires W. A hinge 100H is provided to a rotary shaft 110S-side of the wire holder 100.

The wire holder 100 is mounted to the wire holder support part 500U with being horizontal, as shown in FIG. 14. Therefore, the wire holder support part 500U is provided with a standing lock part 500L at the rear of a part to which the wire holder 100 is mounted. The lock part 500L has an engaging part 500C at a lower side thereof. The engaging part 500C is engaged with an engaging part 100C (refer to FIG. 14) that is provided to the wire holder 100.

Also, the wire holder support part 500U is provided with side rattling prevention ribs 500G at both sides of the part to which the wire holder 100 is mounted. The wire holder 100 is provided between the two side rattling prevention ribs 500G, so that the rattling of the wire holder 100 is suppressed.

Also, the wire holder support part 500U is provided with a standing crimping blade 500M (refer to FIG. 13) facing upwards at a substantial center of the part to which the wire holder 100 is mounted.

FIG. 13 is a side view showing an initial state where the wire holder 100 is mounted to the wire holder support part 500U, in which the wire holder 100 stands from the wire holder support part 500U. In FIG. 13, the rotary shaft 110S (refer to

FIG. 13) provided at the tip of the wire holder 100 is enabled to abut on a holder shaft support part 500S of the wire holder support part 500U, as shown in FIG. 13. At this state, when the wire holder 100 is rotated about the rotary shaft 110S in an arrow direction F1 of FIG. 13, a horizontal state is finally made (refer to FIG. 14).

FIG. 14 is a side view showing a state where the wire holder 100 has been mounted to the wire holder support part 500U. When the wire holder 100 is rotated about the holder shaft support part 500S in the arrow direction F1 of FIG. 13 with a finger abutting on a finger abutting part 110F of the wire holder 100 from a state where the wire holder 100 is rotated to stand as shown in FIG. 13, a tip of the crimping blade 500M is inserted into the wire holder 100 from the outside of the wire holder 100 through a crimping blade insertion hole during the rotation and abuts on sheaths of the wires W. When the tip of the crimping blade 500M abuts on the sheaths of the wires W, a tip 110Z of the wire holder 100 abuts on a backside 500Z of an upper end portion of an L-shaped support rib 500A, which is provided to stand from the tip of the wire holder support part 500U, by a reaction to the force of pressing the finger abutting part 110F about the abutting wires W and the backside 500Z becomes a support point, so that a lever operation is made. Thereby, when the finger abutting part 110F is pressed just with a weak force, the crimping blade 500M at the operating point cuts the sheaths of the wires W and is crimped to cores thereof, so that the crimping blade 500M and the cores of the wires W are electrically connected.

According to the related art, by the lever mechanism in which the backside 500Z of the upper end portion of the L-shaped support rib 500A is the support point, the crimping blade 500M cuts the sheaths of the wires W with the weak force and is then press-contacted to the cores thereof. Therefore, the crimping blade 500M and the cores of the wires W are electrically connected, as shown in FIG. 14.

Also, at this state, the wire holder 100 is locked to the housing 500, as described below.

According to the above related art, the wire holder 100 that is mounted to the wire holder support part 500U with being horizontal is fixed to the housing 500 as the engaging part 100C (refer to FIG. 12) provided to the wire holder 100 is engaged with the engaging part 500C formed at the lower part of the lock part 500L of the housing 500, as shown in FIG. 14.

FIG. 15 is a plan view showing a state where the wire holder has been mounted to the wire holder support part and FIG. 16 is an enlarged plan view of the wire holder support part of FIG. 15. At this state, the wire holder 100 is prevented from rattling, as described below.

In FIGS. 15 and 16, the wire holder 100 is mounted between the two side rattling prevention ribs 500G. The two side rattling prevention ribs 500G are steel members. Hence, when the wire holder 100 is mounted between the two side rattling prevention ribs 500G that are steel members, the rattling of the wire holder 100 is prevented.

### CITATION LIST

### Patent Literature

[PTL 1] JP-A-2011-113802

### SUMMARY OF THE INVENTION

In the above related art, the rattling of the wire holder 100 is prevented by mounting the wire holder 100 between protrusions formed on the two side rattling prevention ribs 500G, as described above. However, the method of preventing the rattling by the steel members such as the two side rattling prevention ribs 500G is not preferable because the high insertion force is required to push in the wire holder 100.

Hence, in order to reduce the insertion force, it is necessary to reduce a wrapping amount between the protrusions of the side rattling prevention ribs 500G and the wire holder 100 as much as possible. However, according to this measure, the effect of preventing the rattling is deteriorated and the rattling in the vertical direction cannot be particularly prevented.

According to the related art, the rattling prevention and the low insertion force have a tradeoff relation.

It is therefore one advantageous aspect of the present invention to provide a wire holder and a wire holder support part capable of preventing rattling sufficiently with a low insertion force.

According to one advantage of the invention, there is provided a wire holder comprising:
a body;
a cover, covering the body, and configured to hold a plurality of wires between the cover and the body;
a hinge connecting the body and the cover;
a lock mechanism, configured to lock the body and the cover, provided at an opposite end portion of the wire holder to the hinge; and
a shaft provided at a side surface of the opposite end portion of the wire holder to the hinge,
wherein the hinge includes a connection part which protrudes from the wire holder in a state where the body and the cover are locked by the lock mechanism.

According to another advantage of the invention, there is provided a housing comprising:
a wire holder support part configured to mount the wire holder thereon; and
a rattling prevention rib, provided at the wire holder support part at a position where the hinge is positioned in a state where the wire holder is mounted to the wire holder support part, and configured to contact the hinge.

The housing may comprise a side rattling prevention rib, provided at the wire holder support part, and configured to press a side surface of the wire holder.

A pressing force to the side surface of the wire holder by the side rattling prevention rib may be smaller than a pressing force to the hinge by the rattling prevention rib.

The housing may comprise a shaft support part, provided at the wire holder support part, and configured to rotatably support the shaft.

According to the invention, the hinge is provided with a rattling prevention function, perceiving that the hinge is not a steel member. Thereby, it is possible to mount the wire holder to the wire holder support part even with a low insertion force. Also, after the mounting, the hinge has the rattling suppression function.

According to the invention, it is possible to obtain the housing by a simple configuration to which the wire holder of the invention (1) can be mounted with the low insertion force and that has no rattling.

According to the invention, it is possible to obtain the housing to which the wire holder can be mounted with the low insertion force and that has no rattling, compared to the related art.

### BRIEF DESCRIPTION OF THE DRAWINGS

FIG. 1 is a perspective view of a wire holder relating according to one embodiment of the invention in a state where the wire holder is opened with respect to a hinge.

FIG. 2 is a perspective view showing the wire holder of FIG. 1 being closed with respect to the hinge.

FIG. 3 is a sectional view taken along an arrow 3A-3A of FIG. 2.

FIG. 4 is a perspective view of the wire holder of FIG. 2, which is seen from the hinge-side.

FIG. 5 is a perspective view of a wire holder and a wire holder support part according to the embodiment of the invention.

FIG. 6 is a side view of the wire holder in an initial state for mounting the wire holder to the wire holder support part.

FIG. 7 is a side view of the wire holder being rotated from the initial state of FIG. 6 for mounting the wire holder to the wire holder support part from.

FIG. 8 is a side view of the wire holder in a state where the wire holder has been mounted to the wire holder support part.

FIG. 9 is a plan view of the wire holder in a state where the wire holder has been mounted to the wire holder support part.

FIG. 10 is an enlarged plan view of the wire holder support part of FIG. 9.

FIG. 11 is an exploded perspective view of an interior light assembly for a vehicle that is a subject of the invention.

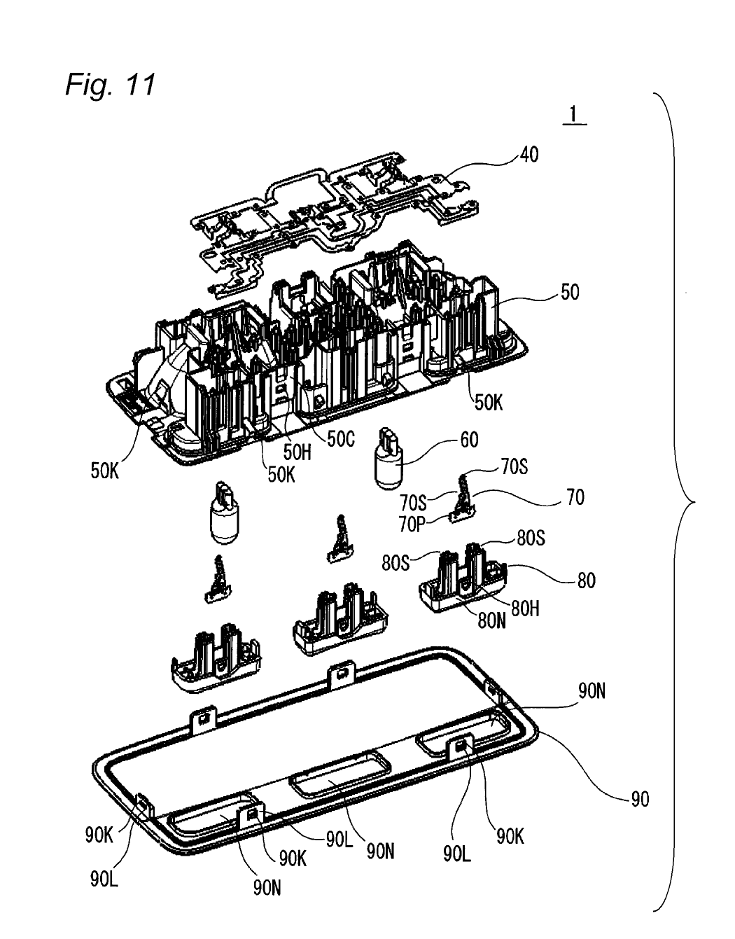

FIG. 12 is a perspective view of a wire holder support part of a housing and a wire holder that is mounted thereto, which is a related art of the invention having improved the technology of PTL 1.

FIG. 13 is a side view of the wire holder of FIG. 12 in an initial state for mounting the wire holder of FIG. 12 to the wire holder support part.

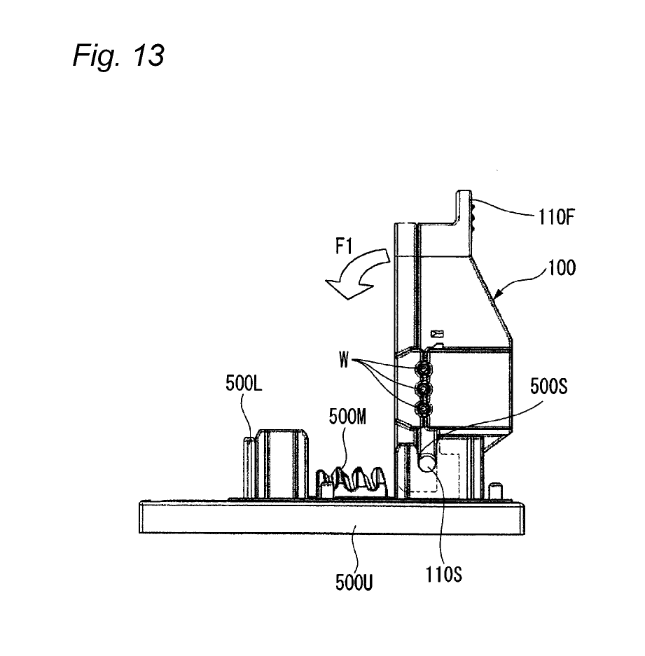

FIG. 14 is a side view of the wire holder of FIG. 12 in a state where the wire holder has been mounted to the wire holder support part.

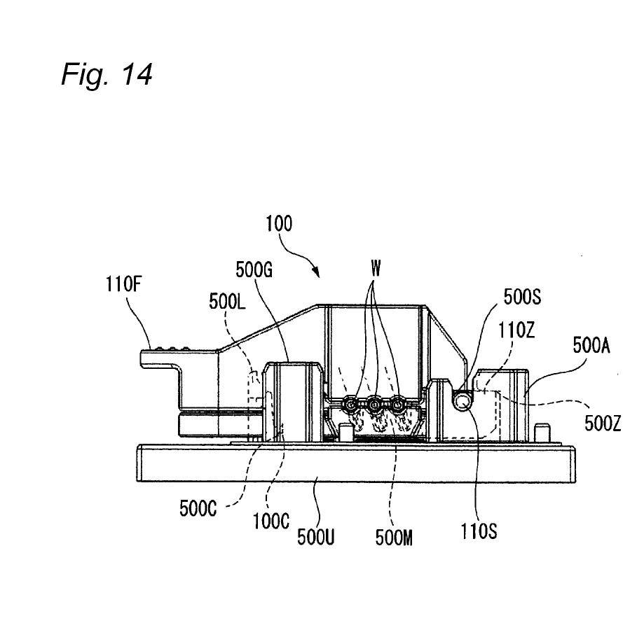

FIG. 15 is a plan view of the wire holder of FIG. 12 in a state where the wire holder of FIG. 12 has been mounted to the wire holder support part.

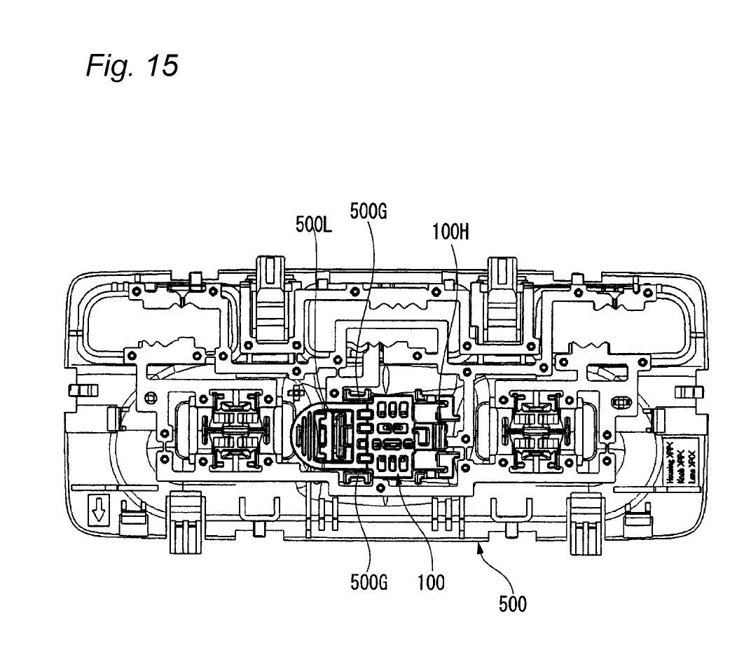

FIG. 16 is an enlarged plan view of the wire holder support part of FIG. 15.

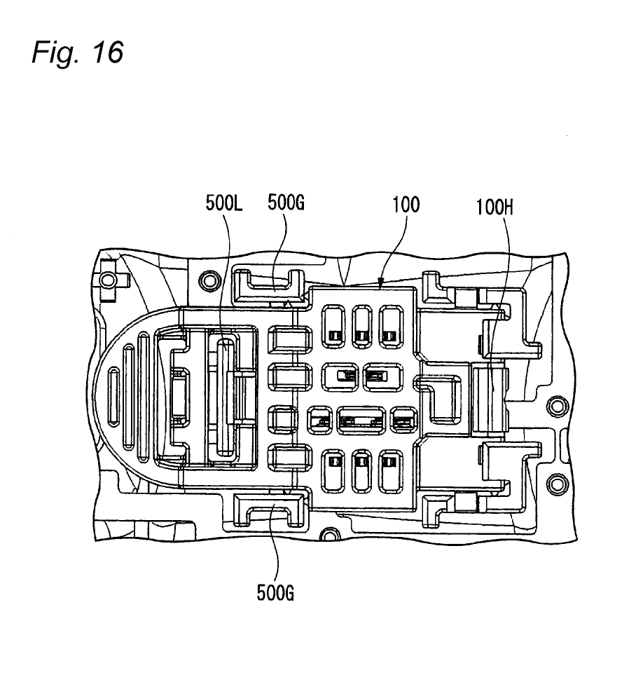

### DETAILED DESCRIPTION OF THE EXEMPLARY EMBODIMENTS

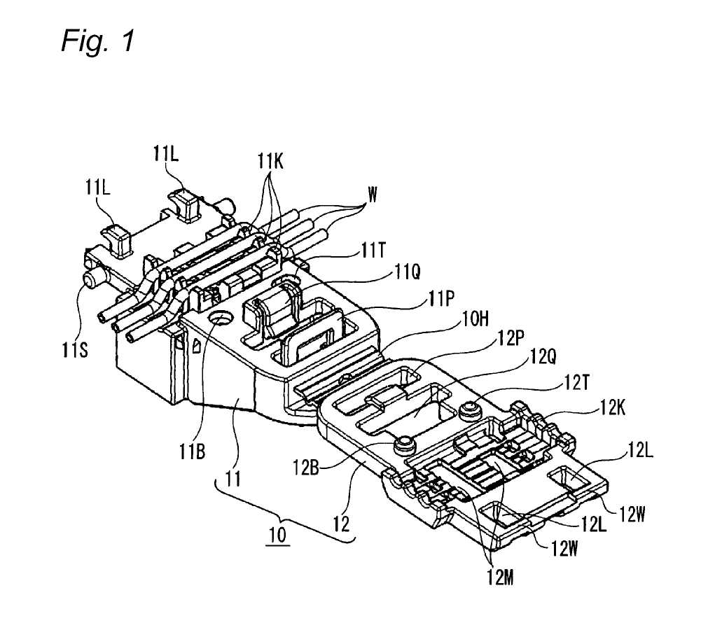

Hereinafter, a wire holder and a wire holder support part capable of preventing rattling sufficiently with a low insertion force will be described with reference to FIGS. 1 to 10.

FIG. 1 is a perspective view showing a state where a wire holder relating to the invention is opened about a hinge.

In FIG. 1, a wire holder 10 relating to the invention has a wire holder body 11 (a body), a wire holder cover 12 (a cover) that covers the wire holder body 11 and a hinge 10H that connects the wire holder body 11 and the wire holder cover 12, which are integrally formed by a resin molding.

An upper surface of the wire holder body 11 includes, from the hinge 10H-side, a first fixing part 11P having a U shape in a downward direction, a second fixing part 11Q having slits formed at both ends thereof and a rectangular shape as a whole, left and right engaging holes 11B, 11T, a plurality of fixing pieces 11K formed at left and right sides so as to fix wires W, and lock claws 11L provided at left and right sides of an opposite end portion to the hinge 10H. A rotary shaft 11S (a shaft) is provided at a side of the wire holder body 11 in the vicinity of the lock claws 11L. The wires W are respectively fixed between the fixing pieces 11K.

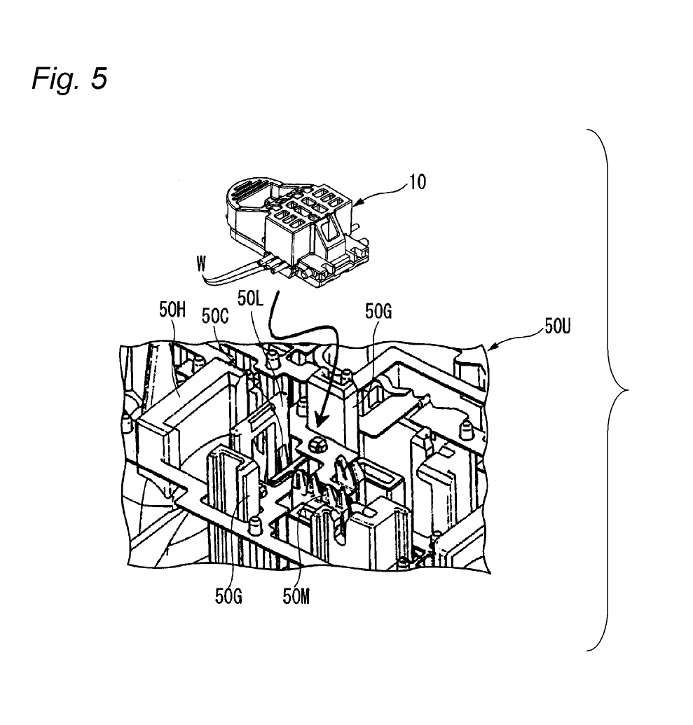

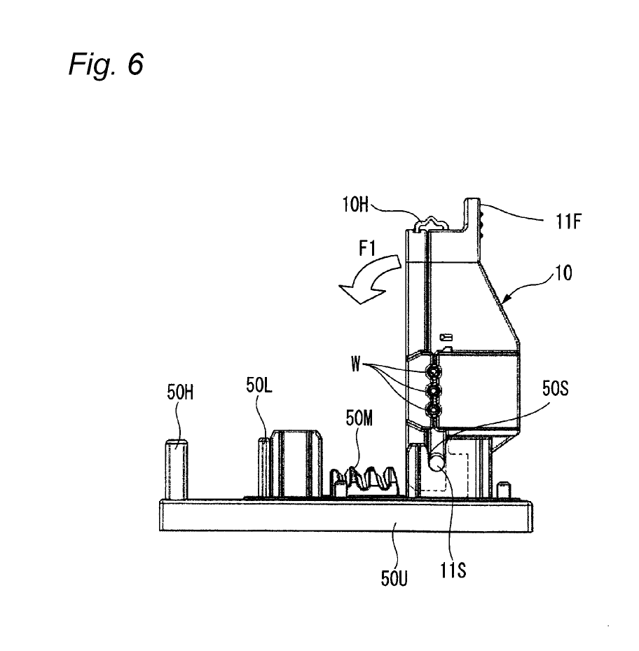

An upper surface of the wire holder cover 12 includes, from the hinge 10H-side, a first insertion hole 12P into which the first fixing part 11P of the wire holder body 11 is inserted, a second insertion hole 12Q into which the second fixing part 11Q of the wire holder body 11 is inserted, fitting bosses 12B, 12T that are respectively fitted into the left and right engaging holes 11B, 11T, wire fixing parts 12K that press the respective wires W fixed to the fixing pieces 11K of the wire holder body 11 from the upper, lock holes 12L that are engaged with the left and right lock claws 11L of the wire holder body 11, and crimping blade insertion holes 12M through which a crimping blade 50M (refer to FIGS. 5 and 6) is inserted into the wires W fixed to the wire fixing parts 12K from an outside of the wire holder cover 12.

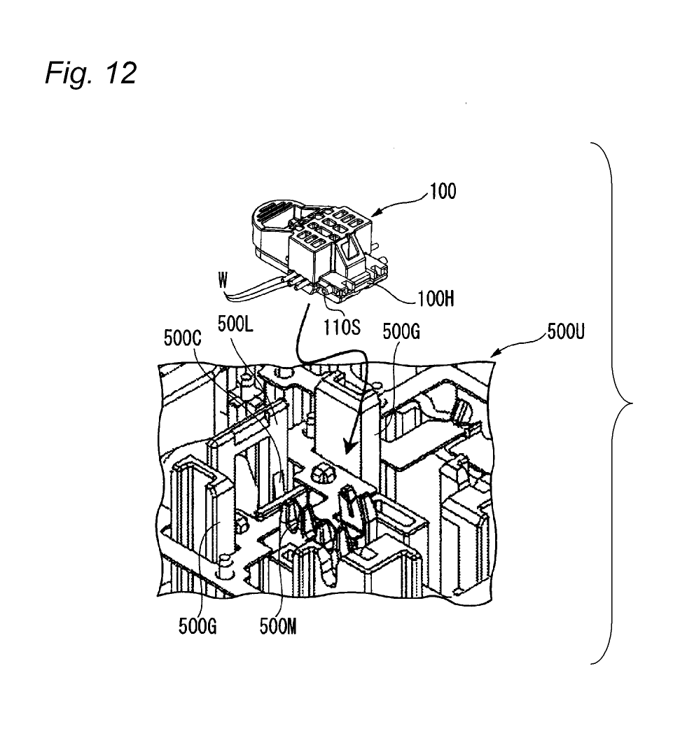

The hinge 10H is a thin plate made of resin and connecting the wire holder body 11 and the wire holder cover 12 and has a hinge function that is provided by the elasticity of the resin material. The hinge 100H of the related art is provided to the rotary shaft 110S-side (refer to FIG. 12). However, according to the invention, the hinge 10H is provided to an opposite side to the rotary shaft 11S-side.

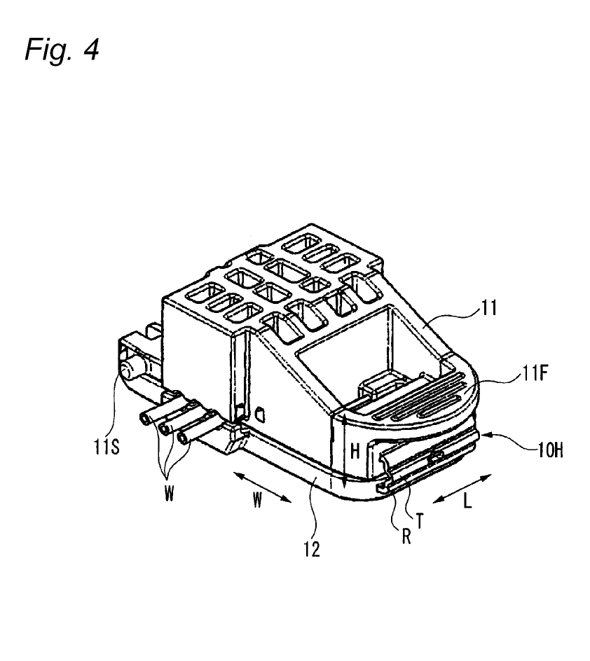

The hinge 10H is a thin plate made of resin having an elastic force and is provided with a connection part R that has a length, which is substantially close to a horizontal width of the hinge 10H in an L direction, as shown in FIG. 4, and protrudes in a reverse rotation axial direction that is a W direction at a state where the wire holder body 11 is covered with the wire holder cover 12 and additionally with a convex part T at a vertex of the connection part R.

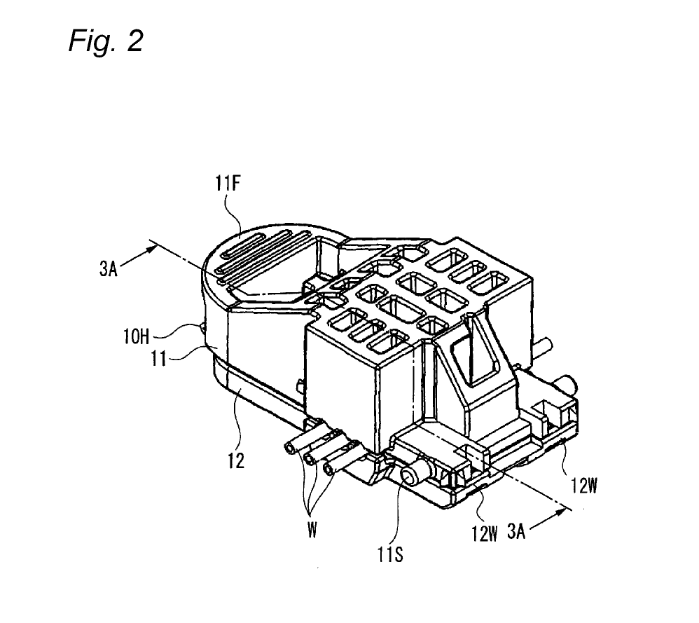

FIG. 2 is a perspective view showing a state where the wire holder of FIG. 1 is closed with respect to the hinge.

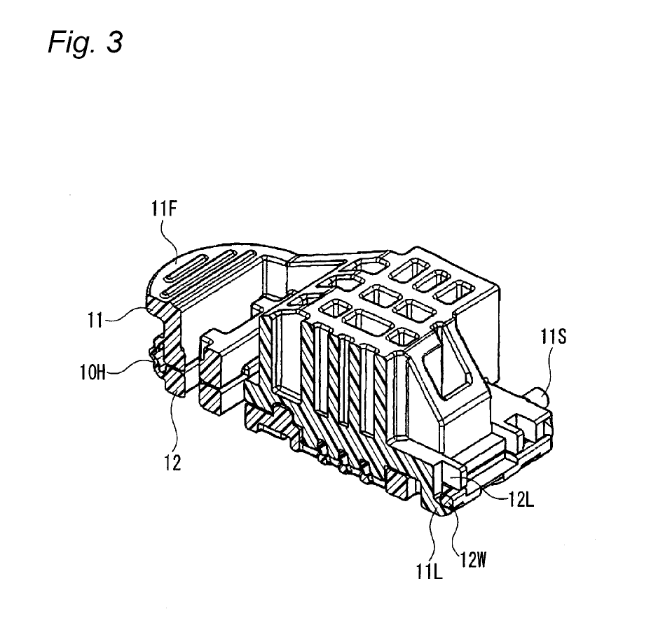

After laying the wires W, when the wire holder body 11 of FIG. 1 is covered with the wire holder cover 12 to thus close the wire holder 10 with respect to the hinge 10H, the left and right lock claws 11L (refer to FIG. 1) of the wire holder body 11 are inserted into the lock holes 12L (refer to FIG. 1) of the wire holder cover 12 at the opposite side to the hinge 10H of the wire holder 10, so that a locked state is made, as shown in FIG. 3.

FIG. 3 is a sectional view taken along an arrow 3A-3A of FIG. 2.

In FIG. 3, an engaging wall 12W is formed between the lock hole 12L and an end portion.

When the lock claw 11L of the wire holder body 11 is inserted into the lock hole 12L of the wire holder cover 12, a tip of the lock claw 11L abuts on the engaging wall 12W, the tip of the lock claw 11L is pushed towards the hinge 10H by the engaging wall 12W, the elastic force of the hinge 10H is applied to thus cause a closing operation with the tip of the lock claw 11L being pushed towards the hinge 10H and the tip of the lock claw 11L is returned and engaged with the engaging wall 12W by the elastic force of the hinge 10H at the time at which the tip of the lock claw 11K goes over the engaging wall 12W.

By doing so, the wire holder body 11 and the wire holder cover 12 are integrally engaged. In other words, the wire holder 10 includes a lock mechanism, which includes the lock claws 11L and the engaging wall 12W, which locks the wire holder body 11 and the wire holder cover 12, at an opposite end portion of the wire holder 10 to the hinge 10H.

FIG. 4 is a perspective view of the wire holder 10 of FIG. 2, which is seen from the hinge 10H-side.

The hinge 10H comprised of the resin thin plate is provided with the connection part R that has a length, which is substantially close to the horizontal width in the L direction, and protrudes in a substantially half-circular shape in the reverse rotation axial direction that is the W direction at the state where the wire holder body 11 is covered with the wire holder cover 12 and additionally with the convex part T at the vertex of the connection part R.

FIG. 5 is a perspective view of the wire holder and the wire holder support part relating to the invention.

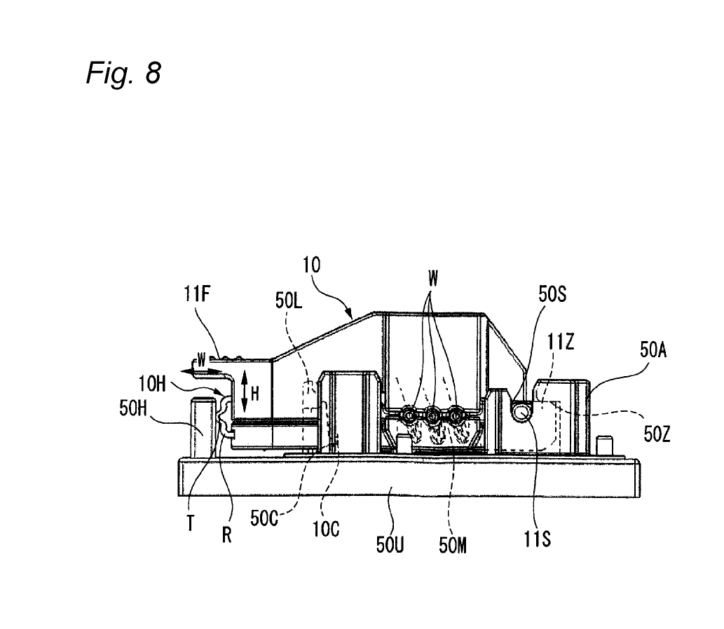

The wire holder 10 is laid with the plurality of wires W, as shown in FIG. 5. The wire holder 10 is accommodated in a wire holder support part 50U with being horizontal, as shown in FIG. 8.

A lock part 50L is provided at the rear of a part to which the wire holder 10 is mounted. The lock part 50L has an engaging part 50C at a lower side thereof, which is engaged with an engaging part 10C (refer to FIG. 8) that is provided to the wire holder 10.

Also, the wire holder support part 50U is provided with side rattling prevention ribs 50G at both sides of the part to which the wire holder 10 is mounted.

The wire holder 10 is provided between the two side rattling prevention ribs 50G, so that the rattling is prevented. The side rattling prevention ribs 50G have a weakened rattling prevention function, compared to the side rattling prevention ribs 500G of the related art, so as to lower the insertion force of the wire holder 10.

Also, the wire holder support part 50U is provided with a crimping blade 50M (refer to FIG. 6) that is provided to stand upwards from a crimping blade protection wall of the housing 50 at a substantial center of the part to which the wire holder 10 is mounted.

Also, a rattling prevention rib 50H of the invention is provided to contact the hinge 10H at a part of the wire holder support part 50U, at which the hinge 10H of the wire holder 10 is positioned, when the wire holder 10 is mounted to the wire holder support part 50U.

The side rattling prevention rib 50G presses a side surface of the wire holder 10. A pressing force to the side surface of the wire holder 10 by the side rattling prevention rib 50H is smaller than a pressing force to the hinge 10H by the rattling prevention rib 50H.

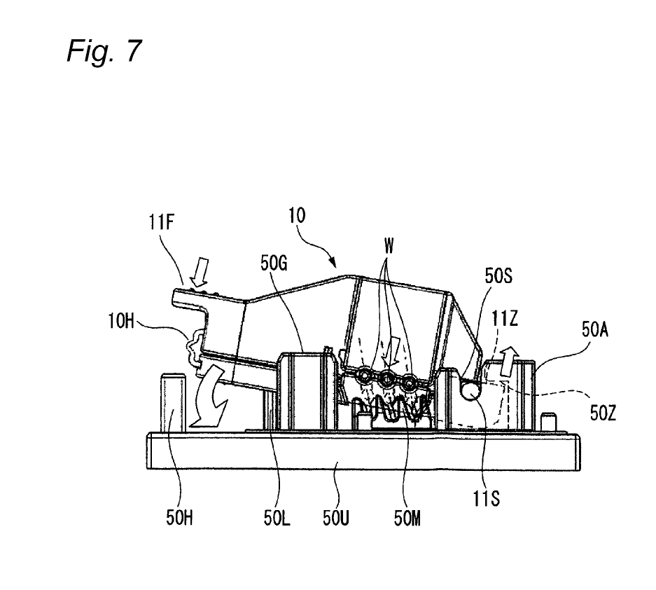

FIG. 6 is a side view showing an initial state where the wire holder 10 is mounted to the wire holder support part 50U, showing a state where the wire holder 10 is made to stand from the wire holder support part 50U. At this time, the hinge 10H that is provided at the opposite side to the rotary shaft 11S by the invention is positioned at the upper. In FIG. 6, the rotary shaft 11S provided at the tip of the wire holder 10 is enabled to abut on a holder shaft support part 50S of the wire holder support part 50U, as shown in FIG. 6. At this state, when the wire holder 10 is rotated about the rotary shaft 11S in an arrow direction F1 of FIG. 6, a state as shown in FIG. 7 is made.

The rotary shaft 11S is provided at a side surface of the opposite end portion of the wire holder 10 to the hinge 10H. The holder shaft support part 50S is provided at the wire holder support part 50U so as to rotatably support the rotary shaft 11S.

FIG. 7 is a side view showing a rotating state where the wire holder 10 is being rotated from the initial state of FIG. 6.

In FIG. 7, a tip of the crimping blade 50M is inserted into the wire holder 10 from the outside of the wire holder 10 through the crimping blade insertion holes 12M (refer to FIG. 1) of the wire holder cover 12 and abuts on sheaths of the wires W. When the tip of the crimping blade 50M abuts on the sheaths of the wires W, a tip 11Z of the wire holder 10 abuts on a backside 50Z of an upper end portion of an L-shaped support rib 50A, which is provided to stand from the tip of the wire holder support part 50U, by a reaction to the force of pressing the finger abutting part 11F about the abutting wires W. When the tip 11Z of the wire holder 10 abuts on the backside 50Z of the upper end portion, the backside 50Z becomes a support point, so that a lever operation is made. Thereby, when the finger abutting part 11F is pressed just with a weak force, the crimping blade 50M at the operating point cuts the sheaths of the wires W and is then crimped to cores thereof, so that the crimping blade 50M and the cores of the wires W are electrically connected.

FIG. 8 is a side view showing a state where the wire holder 10 has been mounted to the wire holder support part 50U.

At this state, the lever operation is made in which the backside 50Z of the upper end portion of the L-shaped support rib 50A becomes the support point. By the lever operation, the crimping blade 50M is crimped to the cores, so that the crimping blade 50M and the cores of the wires W are electrically connected.

Also, at this state, the wire holder 10 mounted to the wire holder support part 50U is fixed to the housing 50 as the engaging part 10C (refer to FIG. 5) provided to the wire holder 10 is engaged with the engaging part 50C formed at the lower part of the lock part 50L of the housing 50, as shown in FIG. 8.

At the state where the wire holder 10 of FIG. 8 is mounted to the wire holder support part 50U, the convex part T of the vertex of the hinge 10H, which is provided to the wire holder 10 by the invention, is pressed (the reaction force is generated) towards the connection part R by the rattling prevention rib 50H that is provided to the housing 50 by the invention.

As a result, the wire holder 10 is suppressed from moving in the vertical direction (the H direction in FIG. 8). In other words, the rattling in the vertical direction is prevented.

The wire holder 10 is suppressed from moving in the front-rear direction (the W direction in FIG. 8). In other words, the rattling in the front-rear direction is prevented.

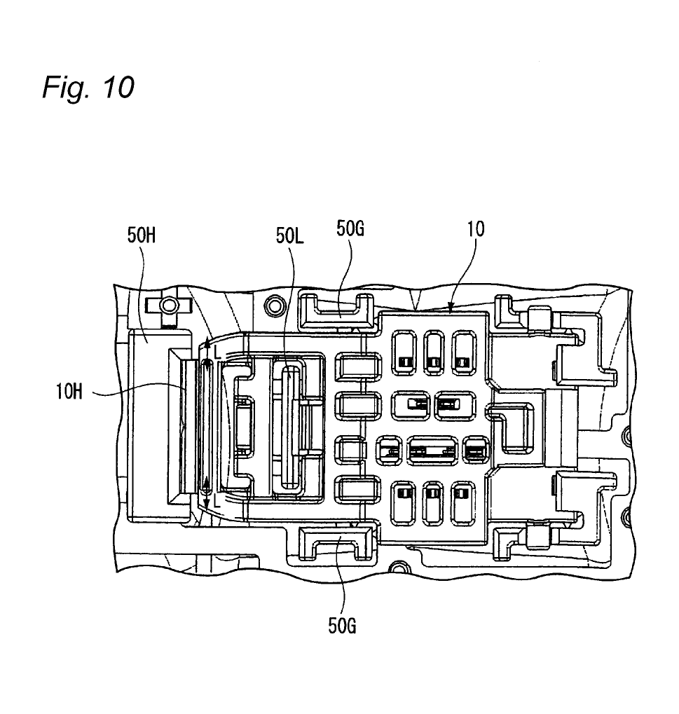

The wire holder 10 is suppressed from moving in the width direction (the perpendicular direction to the sheet in FIG. 8, the L direction in FIG. 10). In other words, the rattling in the width direction is prevented.

As described above, since the hinge 10H is comprised of the resin thin plate, the rigidity thereof is low. Also, since the side rattling prevention ribs 50G have the weakened rattling prevention function so as to reduce the insertion force of the wire holder 10, the wire holder 10 is mounted to the wire holder support part 50U even with the low insertion force. Also, after the wire holder is mounted, the rattling is suppressed in the three directions by the repulsive force of the hinge 10H and the rattling prevention rib 50H.

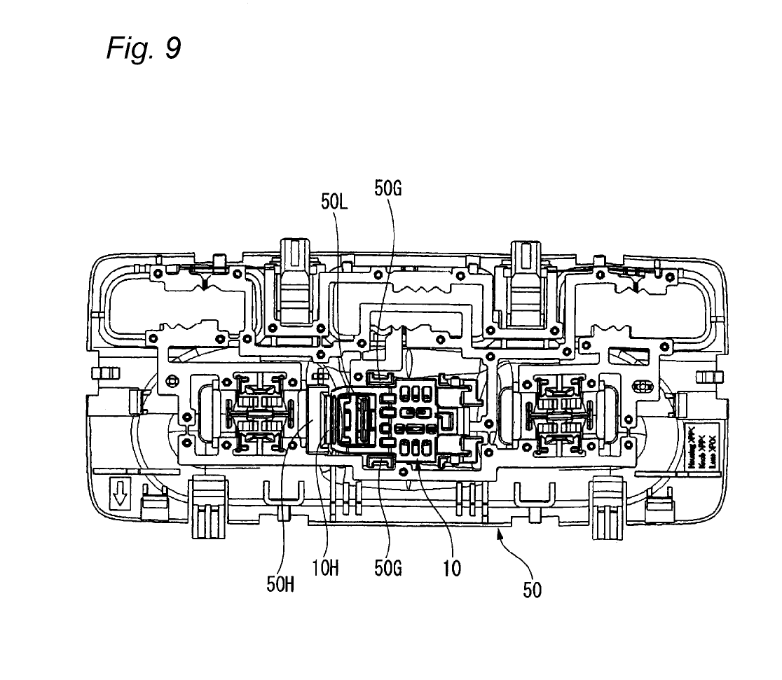

FIG. 9 is a plan view showing a state where the wire holder has been mounted to the wire holder support part and FIG. 10 is an enlarged plan view of the wire holder support part. As described above, since the rattling is mainly prevented by the repulsive force of the hinge 10H and the rattling prevention rib 50H, the rattling suppression by the strong rigid members, which has been made up to now by the two side rattling prevention ribs 50G, is not necessary any more. Therefore, since there is no rattling suppression by the strong rigid members, which has been made by the two side rattling prevention ribs 500G in the related art, even the low insertion force is sufficient and the sufficient rattling prevention effect is implemented by the repulsive force of the hinge 10H and the rattling prevention rib 50H.

According to the invention, since the hinge connecting the wire holder body and the wire holder cover is comprised of the resin thin plate, the hinge having the lower rigidity is pressed by the rattling prevention rib, so that it is possible to sufficiently suppress the rattling in the three directions even with the low insertion force.

Although the present invention has been described in detail by reference to the specific embodiments, it is manifest to those skilled in the art that the present invention be susceptible to various alterations or modifications without departing the spirit and scope or purport of the invention.

According to the present invention, there is provided a wire holder and a wire holder support part capable of preventing rattling sufficiently with a low insertion force.

What is claimed is:

1. A wire holder, configured to hold a plurality of wires between a cover and a body, the wire holder comprising:
the body;
the cover, covering the body;
a hinge connecting the body and the cover;
a lock mechanism, configured to lock the body and the cover, provided at an opposite end portion of the wire holder to the hinge; and
a shaft provided at a side surface of the opposite end portion of the wire holder to the hinge,
wherein the hinge includes a connection part which protrudes from the wire holder in a state where the body and the cover are locked by the lock mechanism.

2. A housing comprising:
a wire holder support part configured to mount the wire holder according to claim 1 thereon; and
a rattling prevention rib, provided at the wire holder support part at a position where the hinge is positioned in a state where the wire holder is mounted to the wire holder support part, and configured to contact the hinge.

3. The housing according to claim 2, comprising:
a side rattling prevention rib, provided at the wire holder support part, and configured to press a side surface of the wire holder,
wherein a pressing force to the side surface of the wire holder by the side rattling prevention rib is smaller than a pressing force to the hinge by the rattling prevention rib.

4. The housing according to claim 2, comprising:
a shaft support part, provided at the wire holder support part, and configured to rotatably support the shaft.
